(19) United States
(12) Patent Application Publication
(10) Pub. No.: US 2003/0169305 A1
(43) Pub. Date: Sep. 11, 2003

(54) System for transmitting state-specifications as entry parameters to virtual reality systems

(76) Inventor: Matthew Erwin Hodges, Cambridge, MA (US)

Correspondence Address: MATTHEW E. HODGES, 23 REED STREET, CAMBRIDGE, MA, 02140, US

(21) Appl. No.: 10/354,717

(22) Filed: Jan. 30, 2003

Related U.S. Application Data
(60) Provisional application No. 60/352,629, filed on Jan. 31, 2002.

(51) Int. Cl. G09G 5/00

(52) U.S. Cl. 345/850

(57) ABSTRACT

A system and methods are disclosed for transmitting state specifications defining a location and state within a virtual reality environment to one or more recipients. The transmitted state specification would permit the recipient to enter into the virtual reality environment at the location specified and with any other included state parameters in effect.

### FIELD OF THE INVENTION

The present invention relates generally to systems designed for the promotion of goods, services, and incentives, and to systems for electronic shopping. Within this field, it focuses on the use of an interactive graphical representation of a real or imagined environment (virtual reality) as a venue for conducting electronic commerce and the related activities of promotion, presentation of incentives, and communication between seller and potential buyer.

The present invention addresses one aspect of communication between seller and buyer; namely, the transmission of an encoded state specification to one or more recipients enabling the recipients to enter the virtual reality system at the specified state or location.

An interactive system capable of generating graphical representation of a real or imagined physical space is herein referred to as a “virtual reality system”. The term “interactive” in this context implies that the user may control or change their view of the system in such a way as to simulate continuous or quasi-continuous movement through the represented space, or otherwise simulate a change of position within the represented space, or to simulate changing the direction or field of view within the represented space. There may be other aspects of control or manipulation within such a system, but user control of viewpoint is the defining characteristic with respect to this invention. The means of representing the space may include raster-based imagery, such as photographs or video images, or vector-based graphical imagery, such as 3-dimensional models rendered by ray-tracing or other methods, or combinations of raster and vector-based imagery.

Virtual reality systems according to this definition may be implemented as a simple collection of views of a place where transitions from one view to another are defined as referential links. Or they may be implemented as dynamical systems where a range of possible states of the system and possible transitions from one state to another are defined in terms of a set of scalar dimensions or mathematical graphs, or combinations of these methods. A set of values specifying such a view, or specifying points along such dimensions, or referencing specific nodes or edges within such a mathematical graph, or combinations of such values, or symbols which can be translated into or used to refer to such values, is referred to herein as a “state specification”.

One implementation of this invention, for example, would allow a seller to transmit a state specification to one or more potential buyers, in order that they may enter the virtual reality system at a desired location and receive promotional information intended by the seller.

### BACKGROUND OF THE INVENTION

This invention was conceived in the course of developing virtual reality systems as venues for the promotion and sale of goods and services over publicly accessible communications networks such as “the Internet”.

It became apparent that sellers promoting goods and services through such systems need a means of transmitting state information to potential customers sufficient that they could be brought into the system at a specific location or state. Furthermore, sellers desired to provide marketing messages, both in the transmitted message and within the virtual reality environment upon entry.

A variety of digitally-encoded messaging systems, including electronic mail and instant messaging systems, have been widely used to distribute promotional and advertising information over publicly accessible communication networks such as the Internet.

The present invention was conceived to address the issue of transmitting state information via such messaging systems as electronic mail and instant messaging, and further to address the desire to incorporate customized content within the transmitted message and within the virtual reality environment at the point of entry and optionally at other locations within the represented space.

### SUMMARY OF THE INVENTION

The present invention comprises a system of methods and processes which enable information in the form of coordinates, nodal references, and other state-defining parameters of a virtual reality system to be transmitted by value or by reference to one or more recipients via publicly accessible communication network in such a manner that recipients may enter into said virtual reality system at the specific state or location desired by the sender.

Methods are disclosed which allow a user of the system, typically a seller or promoter of goods and services, to select the state of the system he wishes to transmit either by reference or by navigating or otherwise manipulating the virtual reality system into the desired state and then initiating a subsequent process, whereby a record is made of all or part of the necessary state information as exemplified by the then current state of the system at the time the request is initiated;

Methods are disclosed which allow the user of the system to compose a message and embed therein or attach thereto such recorded state information or an identification by which said state information may be later retrieved;

Methods are disclosed which allow the user of the system to compose text or other specific content and cause this material to be presented within or in conjunction with the representation of the virtual reality environment upon entry by one or more of the recipients of such a transmitted message;

Methods are disclosed which allow the user of the system to indicate a list of one or more recipient address specifications to which the message should be delivered;

Methods are disclosed by which the user of the system may initiate and manage the transmission of such a message to a desired list of recipients.

### BRIEF DESCRIPTION OF THE DRAWINGS

FIG. 1 is a schematic block diagram illustrating a state-specification delivery system representative of the present invention;

FIG. 2 is a schematic block diagram of the exemplary central controller of FIG. 1;

FIG. 3 illustrates a sample set of tables from the Virtual Reality database of FIG. 2;

FIG. 4 illustrates a sample set of tables from the Seller database of FIG. 2;

FIG. 5 illustrates a sample set of tables from the Recipient List database of FIG. 2;

FIG. 6 illustrates a sample table from the Transmission database of FIG. 2;

FIG. 7 illustrates a sample process for transmitting a state specification of the Virtual Reality Environment of FIG. 2 to a list of recipients.

### DETAILED DESCRIPTION

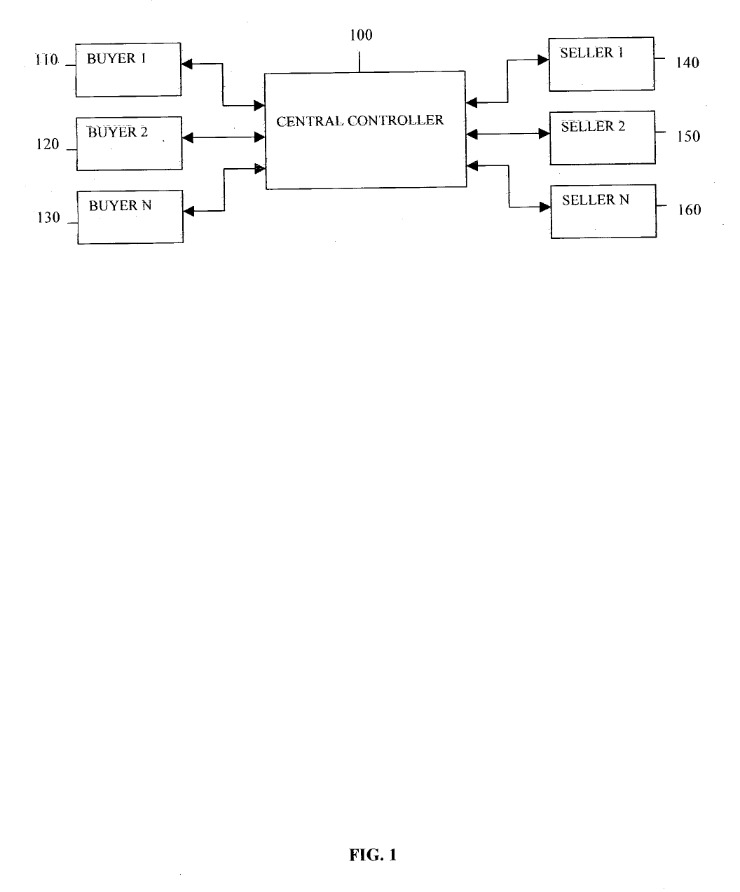

FIG. 1 shows a system for managing the transmission of state information in conjunction with virtual reality environments (VRE) 100. The system receives requests for graphical representations from buyers 110, 120, 130 and requests for creation and transmission of electronic messages from sellers 140, 150, 160.

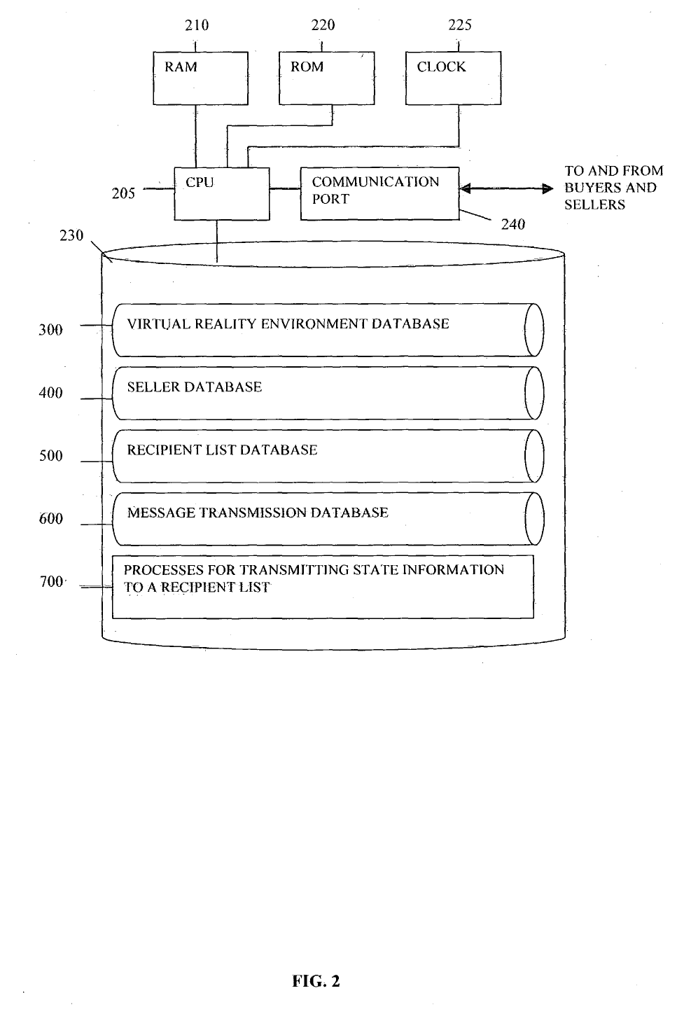

FIG. 2 is a block diagram showing the architecture of an illustrative central controller 100. The central controller 100 includes certain standard hardware components, such as a central processing unit (CPU) 205, a random access memory (RAM) 210, a read only memory (ROM) 220, a clock 225, a data storage device 230, and a communications port 240. The CPU 205 can be linked to each of the other listed elements, either by means of a shared data bus, or dedicated connections, as shown in FIG. 2. The communications port 240 connects the central controller 100 to each buyer 110 and seller 130. The communications port 240 can include multiple communication channels for simultaneously establishing a plurality of connections.

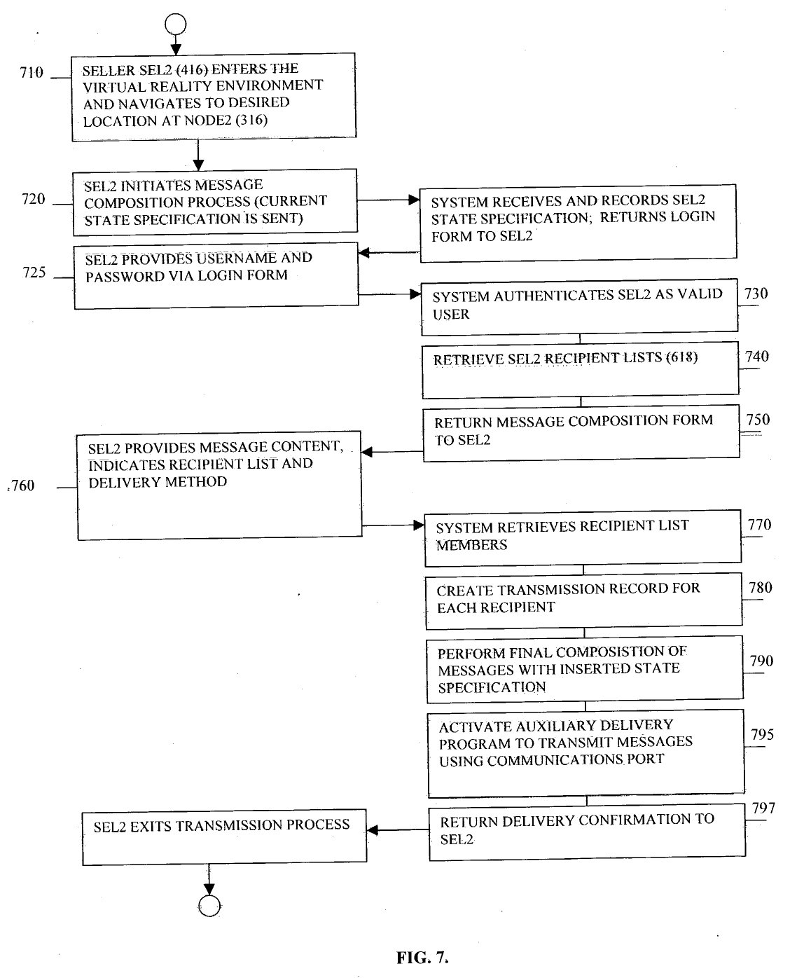

The ROM 220 and/or data storage device 230 are operable to store one or more instructions, discussed further below in conjunction with FIG. 7, which the CPU 205 is operable to retrieve, interpret and execute. For example, the ROM 220 and/or data storage device 230 can store processes to accomplish the retrieval, composition, and delivery of graphic scenes with inserted content and supplemental material to sellers 130 and buyers 110. Similarly, the ROM 220 and/or data storage device 230 can store processes to accomplish the retrieval, composition, and delivery of electronic messages via the communications port 240 to buyers 110, 120, 130.

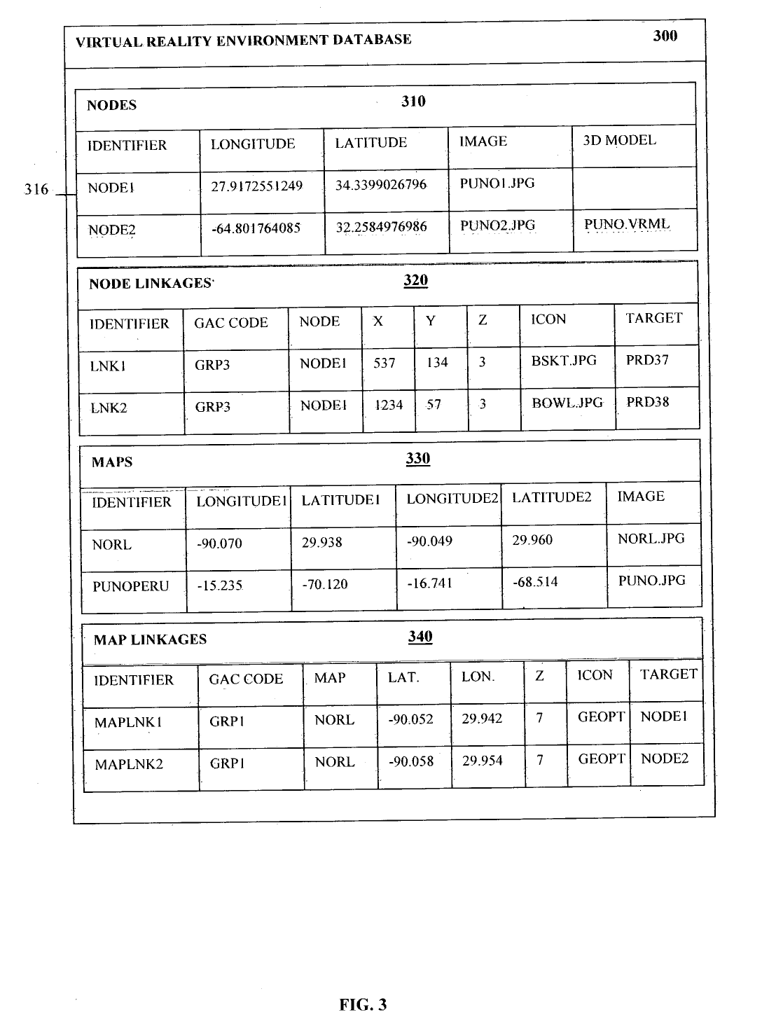

As discussed further below in conjunction with FIGS. 3 through 6, respectively, the data storage device 230 includes a Virtual Reality Environment database 300, a Seller database 400, a Recipient List database 500, and a Message Transmission database 600.

FIG. 3. The Virtual Reality Environment (VRE) database 300 stores information defining all of the discrete loci, or nodes 310, of the virtual reality environment within the VRE system, including geographic coordinates as well as the information required to generate a representation of the environment at that location. The virtual reality environment database also stores information defining connections 320 linking any given location to other locations within the virtual environment and to other information resources within the VRE system accessible from that location, including representations of any objects, product descriptions, or virtual people within the representational bounds of that locus.

The virtual reality environment database also stores information describing all resources used to generate cartographic or isomorphic representations of the virtual reality environment in whole or part 330, as well as the connections 340 from such representations to other information resources within the VRE system 100. Buyers 110, 120, 130 may use these connections to control their movement through the virtual reality environment or to access other information resources including object representations, product descriptions, and virtual people.

It is to be understood that the implementation of a Virtual Reality Environment does not require such a database structure and that the means of implementation of the Virtual Reality Environment is immaterial to the present invention. This figure is included as a sample implementation of a broader class of systems wherein the user could navigate to a desired location and from that point cause the system to derive or otherwise receive the state specification required for the processes central to the present invention.

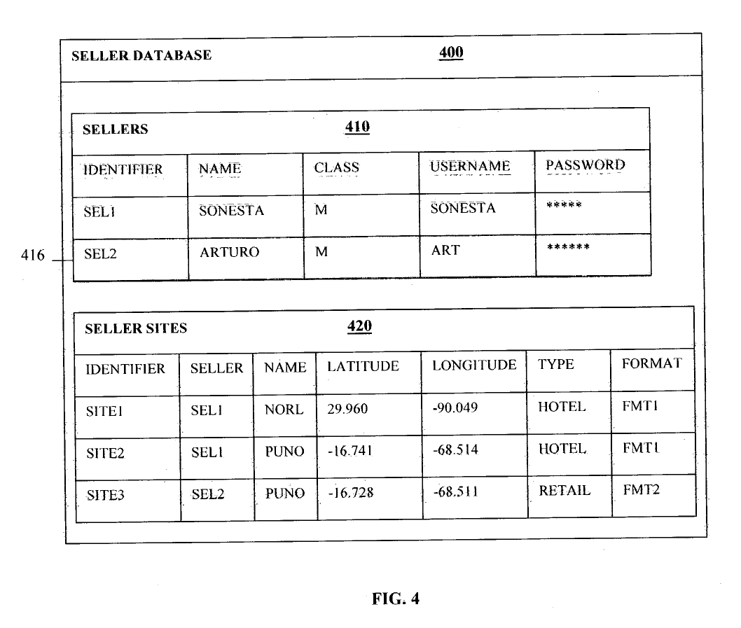

FIG. 4. The Seller database 400 stores information on each seller 140, 150, 160 registered with the VRE system 100, including contact information and username and password 410.

The Seller database 400 also stores information on each location or venue within the virtual reality environment which is associated with each seller 140,150,160, including contact information and type of venue, as well as metric and descriptive information pertinent to each type of location or venue 420.

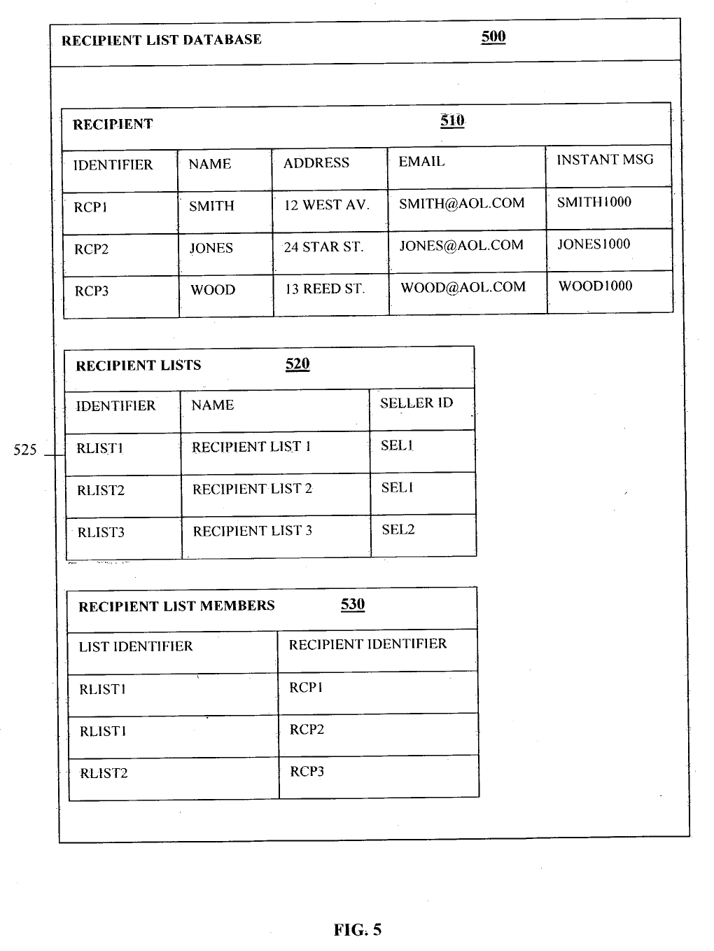

FIG. 5. The Recipient List database 500 stores information on each recipient 110, 120, 130 to whom the seller 416 may transmit a message in a list of recipients 510.

The Recipient List database also includes grouping information permitting a seller 416 to define and maintain one or more independent lists of recipients, as recorded in the Recipient Lists table 520 and the Recipient List Members table 530.

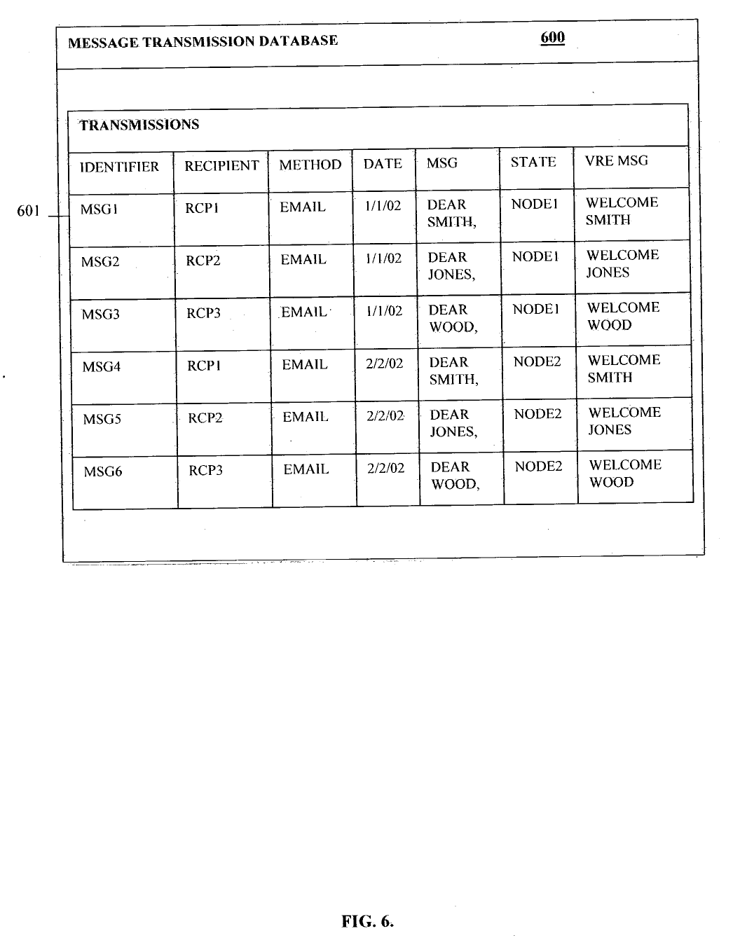

FIG. 6. The Message Transmission database 600 stores information on each message transmitted, including such details as the recipient, the method of transmission, and the date of transmission, as well as the composed message, any state information needed to indicate the destination location within the Virtual Reality environment, and any differentiated content intended for viewing by the recipient upon entry at the specified location.

FIG. 7. The Process for Transmitting State Information to a Recipient List 700 illustrates a sample process by which a seller 416 may compose a message containing state information defining a desired entry point and transmit it to one or more recipients. In this example, the seller 416 first enters the virtual reality environment and navigates to the desired state or location he wishes his recipients to enter 710. He then initiates a message transmission process by triggering an actuating mechanism in the control interface of the virtual reality system. 720, at which time the present state of the virtual reality environment is recorded by the central controller. He provides a username and password in a form provided 725, and upon submission, this information, together with current state information defining his position within the virtual reality environment is returned to the central controller 100. Upon receipt, the central control system authenticates his identity as a registered user 730 by means of reference to the Seller database 400 and retrieves a list of Recipient Lists 520 to which he is permitted access 740.

The central controller system 100 then provides to the user a message-composition form, allowing him to compose whatever text or other data is to be included in the message 750. The composition form also provides a mechanism sufficient to allow the seller to compose differentiated content to be presented to the recipient upon entry into the virtual reality environment. The composition form also allows the seller to select the Recipient List 525 and the delivery method to be used in transmitting the message.

When the user has finished composing these materials 760, the form is submitted to the server. The server then retrieves the appropriate list of recipient addresses 770 and constructs a Message Transmission record 601 for each recipient on the list 780. The system performs final composition of messages, including the insertion of the correctly formatted state information 790. The system may then call an auxiliary process, such as a sendmail program in the case of electronic mail messages, to transmit the messages to their intended recipients 795. Upon completion of the delivery, the system returns a status report to the seller 797.

It is to be understood that the embodiments and variations shown and described herein are merely illustrative of the principles of this invention and that various modifications may be implemented by those skilled in the art without departing from the scope and spirit of the invention.

What is claimed is:

1. A system for transmitting information defining a state or location within a virtual reality environment to one or more recipients, comprising:
a process for generating representations of a physical or imaginary multi-dimensional space that is responsive to a plurality of individual users requesting specific representations based upon a state, or location, within the space (hereinafter referred to as a virtual reality environment),
a process for receiving requests from and distributing representations of a virtual reality environment to a plurality of individual users;
a method for encoding state information sufficient to allow the virtual reality environment to generate a known representation;
a method for transmitting such encoded state information to one or a plurality of recipients;
a method for recipients to present such received state information to the controlling process of the virtual reality environment as parameter to a request for the corresponding representation encoded therein.

2. A system, according to claim 1, wherein the method for generating representations of the physical or imaginary space is effected by means of vector-based graphic systems rendered as ray-traced projections (including VRML or so-called 3-dimensional models);

3. A system, according to claim 1, wherein the method for generating representations of the physical or imaginary space is effected by means of raster-based images rendered as cylindrical or spherical projections (including panoramic photography);

4. A system, according to claim 3, wherein the method for generating representations of the physical or imaginary space is effected by means of a continuous sequence of raster-based images derived from digitally-encoded video signals and rendered as cylindrical or spherical projections;

5. A system, according to claim 1, 2, 3, or 4 wherein the method for receiving requests and distributing representations of a virtual reality environment is effected by means of a publicly accessible communications network such as the Internet;

6. A system according to claim 1, 2, 3, 4, or 5, further comprising
a method for modifying the rendition of the virtual reality environment through the addition or deletion of inserted content materials selected on the basis of an identification code or state parameter, where such inserted content materials may be integrated directly into the rendition of the space represented in the virtual reality environment as represented objects or icons or overlaid graphical elements, or may be displayed above or beside or otherwise in association with such rendition of the virtual reality space, and where the inserted content materials may include (but not be limited to) information encoded as text, graphical imagery, audio, or video signals;
a method for generating unique identification codes or unique values of one or more state parameters which may be used as the basis of selection of such inserted content materials;
a method for associating one or more items of inserted content material with such identification codes or state parameter values of the virtual reality environment.
a method for storing inserted content material in such a way as to be accessible by the controlling process of the virtual reality environment;
a method for deleting inserted content material.

7. A system according to claim 5 or claim 6, wherein the method for transmitting messages is effected by means of an asynchronous message delivery system such as an electronic mail protocol deployed over a publicly accessible communications network such as the Internet.

8. A system according to claim 5 or claim 6, wherein the method for transmitting messages is effected by means of an electronic instant message relay system over publicly accessible communications network such as the Internet.

9. A system according to claim 7 or claim 8, further comprising
a method for combining the encoded state information contained in the transmitted message together with additional supplemental content which may include (but not be limited to) information encoded as text, graphical imagery, audio, or video signals;
a method for composing and storing such supplemental message content in such a way as to be accessible to the message generation and transmission process of the virtual reality environment.

10. A system according to any of claims 1 through 9, further comprising:
a method for maintaining information records describing a plurality of individual recipients sufficient to be used in addressing and delivering the transmitted messages containing state information, and in such manner as to be accessible to the message transmission process of the virtual reality environment;
a method for indicating a plurality of such records and of transmitting messages containing encoded state information to each of them.
